(19) United States
(12) Patent Application Publication
(10) Pub. No.: US 2020/0128807 A1
(43) Pub. Date: Apr. 30, 2020

(54) FISH HOLDING TOOL

(71) Applicants: Tucker Hoge, Jackson, MS (US); Cam Hoge, Jackson, MS (US); William Hoge, Jackson, MS (US)

(72) Inventors: Tucker Hoge, Jackson, MS (US); Cam Hoge, Jackson, MS (US); William Hoge, Jackson, MS (US)

(21) Appl. No.: 16/172,263

(22) Filed: Oct. 26, 2018

(51) Int. Cl. A01K 97/18; B25B 7/02; B25B 7/12

(52) U.S. Cl. CPC A01K 97/18; B25B 7/123; B25B 7/02

(57) ABSTRACT

A fish holding tool for safe and secure holding of a caught fish for purposes such as removing a hook from its mouth. The fish holding tool operates as a pliers having a planar four-bar toggle linkage, where the upper jaw of the upper member remains stationary and the lower jaw is opened and closed by manipulation of the lower handle. The fish holding tool is made of a lightweight, buoyant material, and allows stability by the positioning of a lower-jaw tab into an upper-jaw slot and by a toggle linkage having a toggle-linkage bumper. The fish holding tool provides a tapered extending tip on the forward end of the upper jaw, which facilitates the opening of the mouth of the caught fish even where the fish forcefully holds its mouth closed in reaction to having been hooked. In order to facilitate easy and secure gripping in wet conditions with a struggling fish, the fish holding tool provides a molded grip texture on the outer surfaces of both the upper handle and the lower handle and provides an upper-handle bulbous end and a lower-handle bulbous end. The fish holding tool also provides a lanyard with a buoyant lanyard-end terminator that facilitates easy retrieval, a secure grip during use, and buoyancy of the entire tool if dropped into the water.

### BACKGROUND OF THE INVENTION

This invention provides a fish holding tool for safe and secure holding of a caught fish for purposes such as removing a hook from its mouth.

Landing or removing a caught fish from the water, removing the hook from its mouth, and placing it on a stringer or in a container are difficult aspects of fishing because of the struggling of the fish and the sometimes awkward, unbalanced, extending positions or stances required to be taken by the fisher reaching towards the water, possibly from a rocking boat. If it is desired not to injure the fish, such as with catch-and-release fishing, it becomes even more difficult. Tools are known which are intended to make these tasks easier and safer, but such known tools tend to underperform, sometimes by being too rigid and solid, therefore injuring the fish and tending to sink when dropped in the water, sometimes by being too lightweight, therefore tending to twist and deform and failing to maintain a grip in use, and oftentimes by being difficult to take in hand when needed, and difficult to keep a grip on and use in real fishing conditions.

What is needed is a fish holding tool that can achieve the stability of rigid, dense materials but using lighter, buoyant materials, and which is easy, safe, and secure to take in hand and use under real fishing conditions.

### SUMMARY OF THE INVENTION

This invention provides a fish holding tool for safe and secure holding of a caught fish for purposes such as removing a hook from its mouth. The fish holding tool operates as a pliers having a planar four-bar toggle linkage, where the upper jaw of the upper member remains stationary and the lower jaw is opened and closed by manipulation of the lower handle. The fish holding tool is made of a lightweight, buoyant material, having potential to be deformable and unstable when closed upon the lower mouth of a struggling fish, especially if too much gripping force is applied, making it likely that the fish will be harmed and the gripping tool will distort. The fish holding tool avoids the potential stability problem by the positioning of a lower-jaw tab into an upper-jaw slot, and by a toggle linkage having a toggle-linkage bumper, which also operates to prevent excessive pressure applied to the lower handle from distorting the tool or damaging the fish.

The fish holding tool provides a tapered extending tip on the forward end of the upper jaw, which facilitates the opening of the mouth of the caught fish even against a “lockjaw” condition where the fish forcefully holds its mouth closed in reaction to having been hooked.

In order to facilitate easy and secure gripping in wet conditions with a struggling fish, the fish holding tool provides a molded grip texture on the outer surfaces of both the upper handle and the lower handle and provides an upper-handle bulbous end and a lower-handle bulbous end. The fish holding tool also provides a lanyard with a buoyant lanyard-end terminator which facilitates easy retrieval, a secure grip during use, and buoyancy of the entire tool if dropped into the water.

### BRIEF DESCRIPTION OF THE DRAWINGS

Reference will now be made to the drawings, wherein like parts are designated by like numerals, and wherein:

FIG. 1 is a left-side view of the fish-holding tool of the invention;

FIG. 2 is a right-side view of the fish-holding tool of the invention;

FIG. 3 is an underneath perspective view of the fish-holding tool of the invention;

FIG. 4 is a cross-section view through a forward section of the fish-holding tool of the invention;

FIG. 5 is a cross-section view through a rearward section of the fish-holding tool of the invention;

FIG. 6 is a left-side view of the fish-holding tool of the invention in an open state;

FIG. 7 is a left-side exploded view of the fish-holding tool of the invention;

FIG. 8 is a right-side exploded view of the fish-holding tool of the invention;

FIG. 9 is a top view of the fish-holding tool of the invention;

FIG. 10 is a bottom view of the fish-holding tool of the invention;

FIG. 11 is a front view of the fish-holding tool of the invention; and

FIG. 12 is a back view of the fish-holding tool of the invention.

### DETAILED DESCRIPTION OF THE INVENTION

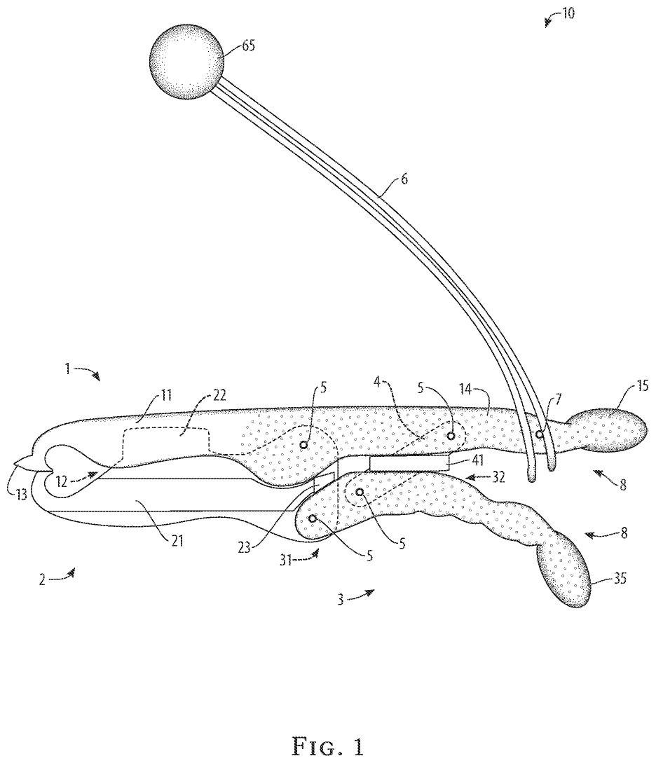

Referring to FIG. 1 and all of the figures generally, the fish holding tool 10 of the invention is shown. The fish holding tool 10 operates as a pliers, where the upper jaw 11 of the upper member 1 remains stationary and the lower jaw 2 is opened and closed by manipulation of the lower handle 3. The fish holding tool 10 is made of a lightweight, buoyant material, making stability when closed upon the lower mouth of a struggling fish a potential problem, especially if too much gripping force is applied, making it likely that the fish will be harmed and the gripping tool will distort. When the fish holding tool 10 is closed, it is here stabilized by the positioning of a lower-jaw tab 22 into an upper-member slot 12, and by a toggle linkage 4 having a toggle-linkage bumper 41, which also operates to prevent excessive pressure applied to the lower handle 3 from distorting the tool or damaging the fish.

The fish holding tool 10 provides a tapered extending tip 13 on the forward end of the upper jaw 11, which facilitates the opening of the mouth of the caught fish even against a “lockjaw” condition where the fish forcefully holds its mouth closed in reaction to having been hooked.

In order to facilitate easy and secure gripping in wet conditions with a struggling fish, the fish holding tool 10 provides a molded grip texture 8 on the outer surfaces of both the upper handle 14 and the lower handle 3, and provides an upper-handle bulbous end 15 and a lower-handle bulbous end 35. The fish holding tool 10 also provides a lanyard 6 with a buoyant lanyard-end terminator 65 which facilitates easy retrieval, a secure grip during use, and buoyancy of the entire tool if dropped into the water.

The fish holding tool 10, when in use, has nominally upper and lower, or vertical, front and back, or axial, left and right, or lateral, orientation, as shown.

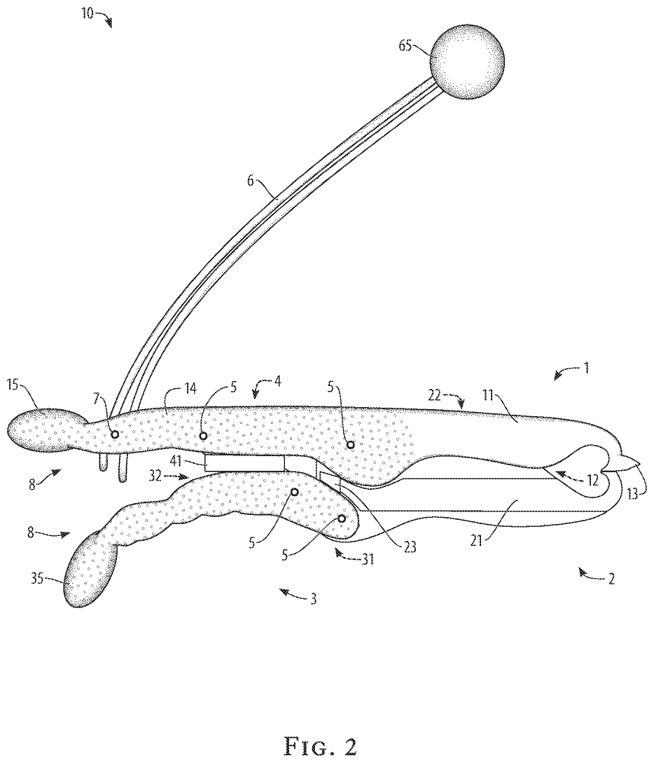

Referring additionally to FIG. 2 and FIG. 3, the major units of the fish holding tool 10 are the upper member 1, which provides both an upper jaw 11 and an upper handle 14 in a single piece, a lower jaw 2, a lower handle 3, a toggle linkage 4, four non-corroding pivot pins 5, a lanyard 6, and a non-corroding lanyard pin 7. The upper member 1, lower jaw 2, lower handle 3, and toggle linkage 4 are made by molding a non-corroding, buoyant, stiff, strong material such as a plastic, resin, or composite. Also, the material should be suitable as jaws which will grip the lower mouth of the fish without excessive damage. A material having the proper properties will not be extremely strong, but will be bendable and deformable in use. The incorporation of air bubbles or buoyant cellulosic material, such as sawdust, into the moldable material can increase the buoyancy, at the expense of a certain amount of structural strength. This weakening of the material is compensated for by the structure of the fish holding tool 10, which, when closing and when closed provides bracing and reinforcement against the likely twisting motion of the fish, while preventing the application of too much force to the jaws, which would distort and damage the tool, and would likely injure the fish.

A molded grip texture 8 is molded into the upper handle 14 and lower handle 3 during manufacture. An upper-handle bulbous end 15 and a lower-handle bulbous end 35 are provided. A lanyard 6 with a buoyant lanyard-end terminator 65 is also provided. Together, these facilitate both the initial taking up in hand of the fish holding tool 10, and the secure use and operation of the fish holding tool 10 on a struggling hooked caught fish. The buoyancy of the entire fish holding tool 10, plus the added buoyancy of the buoyant lanyard-end terminator 65, ensure that in the likely event that the fish holding tool 10 is dropped in the water, it will be retrievable. The size and substantially ball-like shape of the buoyant lanyard-end terminator 65 provides a good way to take up the fish holding tool 10 from a tackle box or the bottom of a boat, or to fish it out of the water.

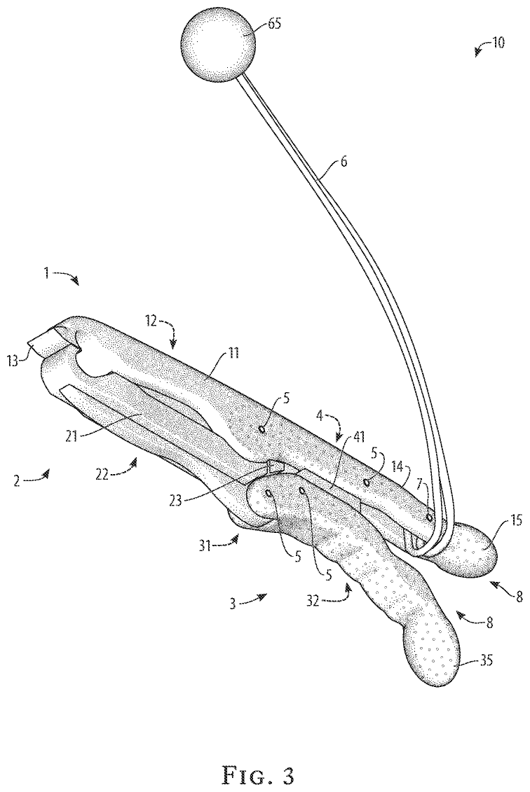

Referring to FIG. 4, toward the front of the fish holding tool 10 the lower jaw 2 is stiffened and supported by a lower-jaw strut 21, and the closed or closing tool is supported against twisting and distortion by the placing of a lower-jaw tab 22 into an upper-member slot 12, as further described herein.

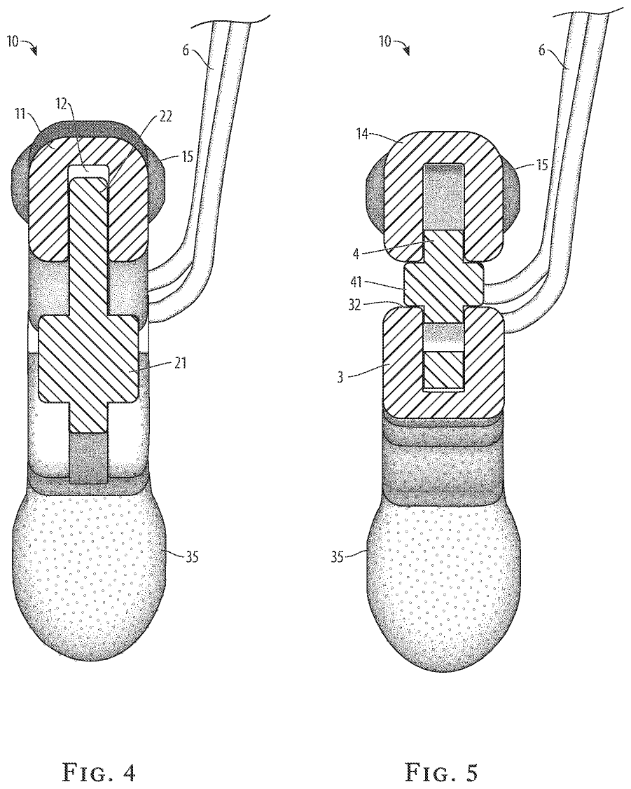

Referring to FIG. 5, toward the back of the fish holding tool 10 the toggle linkage 4 is pivotally linked to and sits partially within slots in both the upper handle 14 and the lower handle 3, which itself provides some support against twisting and distortion. The toggle linkage 4 is provided with a toggle-linkage bumper 41 which both strengthens the toggle linkage 4 and stops any further movement of the lower handle 3 towards the upper handle 14. Stopping the further movement of the lower handle 3 prevents the fish holding tool 10 from being forced to close more and more tightly than intended, which would distort and weaken the tool, and would likely injure the caught fish. Also, the toggle linkage 4 and toggle-linkage bumper 41, when squeezed between the upper handle 14 and a lower-handle brace 32 on the lower handle 3, further stabilizes and supports the handles against twisting and distortion.

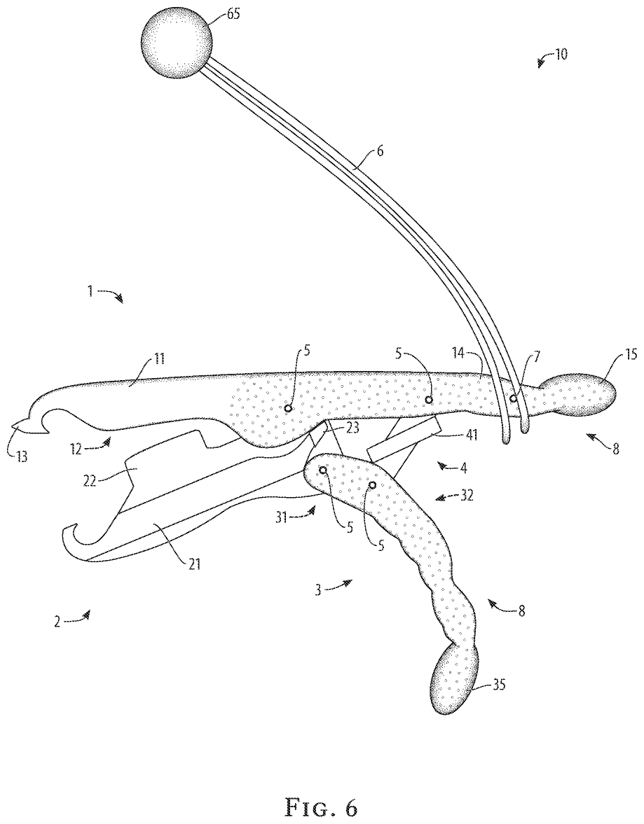

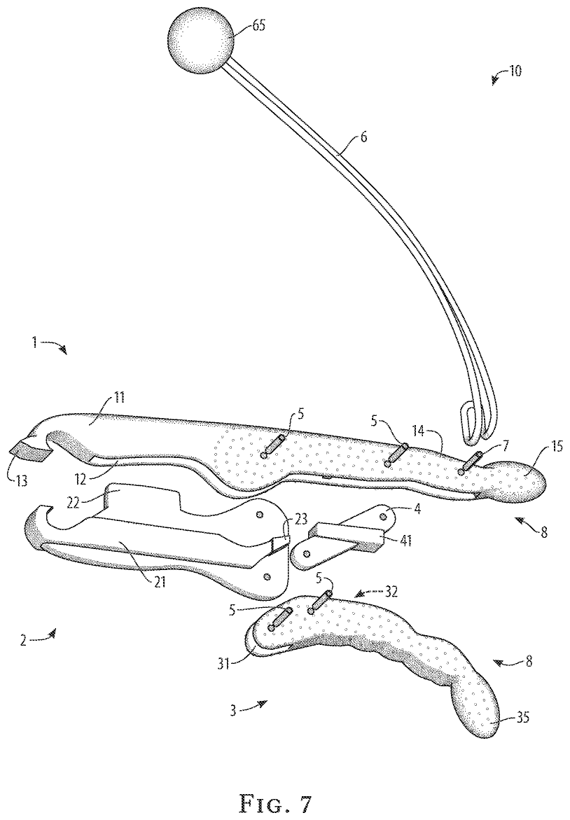

Referring to FIG. 6, FIG. 7, and FIG. 8, in exploded view, the upper member 1, providing an upper jaw 11 with a tapered extending tip 13, and an upper handle 14 with an upper-handle bulbous end 15 and a molded grip texture 8, is provided further with an upper-member slot 12 along the lower surface, and facing downward. The edges of the upper-member slot 12 are rounded or beveled to avoid a sharp edge which might injure a user's hand and in order to facilitate and guide the movement of objects into and out of the slot. Two pivot-pin holes, one forward and one backward, passing through the upper member 1 and upper-member slot 12, perpendicular to the front-to-back axis, are provided toward the middle and rear-middle, to accommodate two non-corroding pivot pins 5, as shown. The non-corroding pivot pins 5 are made of a strong, non-corroding, non-rusting material such as 316 stainless steel, or a suitable plastic, resin, or composite material. If 316 stainless steel is used, the non-corroding pivot pins 5 can be in the form of roll pins, with enough spring to hold fixed in place. Other materials would require suitable fixing in place.

At the back of the upper-member slot 12 the lanyard 6 is secured to the upper handle 14 with a non-corroding lanyard pin 7 through a suitable hole, as shown. The considerations for the non-corroding lanyard pin 7 are substantially the same as for the non-corroding pivot pins 5, above.

The lower jaw 2 is provided with a lower-jaw strut 21, which is a lateral thickening of the lower jaw along the portion extending forward to terminate the jaw, as shown, for strength and stability of the lower jaw without increasing the weight and bulk of the lower jaw.

The lower jaw 2 is provided with a lower-jaw tab 22 on the middle upper portion of the lower jaw. The lower-jaw tab 22 has a lateral width corresponding to the width of the upper-member slot 12, such that the lower-jaw tab 22 fits snugly into the upper-member slot 12, but is able move into and out of the slot, in use. The edges of the lower-jaw tab 22 are rounded, beveled, or tapered such that the lower-jaw tab 22 is guided into the upper-member slot 12. When the lower-jaw tab 22 is seated in the upper-member slot 12, the fish holding tool 10 is strengthened and stabilized against twisting and distortion. The lower-jaw tab 22 is shaped such that a portion of the tab will enter into the upper-member slot 12 early during the process of closing the jaw, in order to provide strength and stabilization early in the process of gripping the caught fish.

The lower jaw 2 is provided with two pivot-pin holes, one above and one below, near the back of the lower jaw 2, to accommodate non-corroding pivot pins 5 as treated below. The lower jaw 2 is provided with a lower-jaw double-stop 23 to stop against either the upper member 1 or the lower handle 3 and prevent over-opening or over-closing of the jaw, as treated below.

The lower handle 3 is of a curved shape overall, with an undulating lower surface providing finger grips, and provides a lower-handle bulbous end 35 and a molded grip texture 8 to the facilitate the user taking up and manipulating the fish holding tool 10. The lower handle 3 provides a lower-handle slot 31 in the forward and the forward-upper portion of the handle, as shown. In a preferred embodiment, as shown, the lower-handle slot 31 is of the same lateral width as the upper-member slot 12, allowing the structures intended to fit into those slots to be of a uniform width, as well. Optionally, the lower-handle slot 31 can be extended rearward in order to lower the amount of material in the handle. A lower-handle brace 32 is provided on the middle, upper surface of the lower handle 3. The lower-handle brace 32 extends laterally across the upper surface of the lower handle 3, and both strengthens and stabilizes the lower handle 3, and provides a surface for the toggle-linkage bumper 41 to stop against, as treated below.

Two pivot-pin holes, one forward and one rearward, are provided both near the front of the lower handle 3, running laterally through the lower handle and the lower-handle slot 31, to accommodate two non-corroding pivot pins 5, as shown, and as treated below.

The toggle linkage 4 is of a lateral width corresponding to the widths of the upper-member slot 12 and the lower-handle slot 31, and is meant to pivot within both slots. The toggle linkage 4 is elongated with pivot-pin holes at opposite ends. The toggle linkage 4 is provided with a toggle-linkage bumper 41 that strengthens the toggle linkage 4, stops any further movement of the lower handle 3 towards the upper handle 14, and, when squeezed between the upper handle 14 and the lower-handle brace 32 on the lower handle 3, further stabilizes and supports the handles against twisting and distortion.

In assembly of the fish holding tool 10, the upper back portion of the lower jaw 2 is placed into the upper-member slot 12 such that the upper pivot-pin hole of the lower jaw 2 is in line with the forward pivot-pin hole of the upper member 1, and is secured in place by a non-corroding pivot pin 5, forming a pivot, or revolute, joint with one degree of freedom. The lower back portion of the lower jaw 2 is placed into the lower-handle slot 31 such that the lower pivot-pin hole of the lower jaw 2 is in line with the backward pivot-pin hole of the upper member 1, and is secured in place by a non-corroding pivot pin 5, forming another pivot joint.

In assembly, the upper backward portion of the toggle linkage 4 is placed into the upper-member slot 12 such that the upper, backward pivot-pin hole is in line with the backward pivot-pin hole of the upper member 1, and is secured in place by a non-corroding pivot pin 5, forming another pivot joint. The lower forward portion of the toggle linkage 4 is placed into the lower-handle slot 31 of the lower handle 3 such that the lower, forward pivot-pin hole is in line with the forward pivot-pin hole of the lower handle 3, and is secured in place by a non-corroding pivot pin 5, forming another pivot joint.

In use, movement of the lower handle 3 upward and toward the upper handle 14 will move the lower jaw 2 toward the upper jaw 11, closing the fish holding tool 10. The lower-jaw double stop 23 will stop against the lower handle 3, will provide some resistance to further, excessive movement of the lower handle 3, and will apply a counteracting opening force to the lower jaw 2. Movement of the lower handle 3 downward and away from the upper handle 14 will move the lower jaw 2 away from the upper jaw 11, opening the fish holding tool 10. The lower-jaw double stop 23 will stop against the upper member 1 and limit the amount or degree of opening.

In use, the fish holding tool 10 functions as a planar four-bar toggle linkage, with four pivot or revolute joints each having one degree of freedom. The structure and the materials used in the fish holding tool 10 allow just enough deformation of the toggle linkage 4 to reach just beyond the toggle position, where the linkage folds and the fish holding tool 10 becomes locked into position, clamping upon the lower mouth of the caught fish with sufficient, but not excessive, force. Any application of additional force to the handles, as would be likely to happen during the handling of a struggling caught fish, is stopped and prevented from increasing the clamping force or deforming the tool by the toggle-linkage bumper 41 preventing any further movement of the lower-handle brace 32 toward the upper handle 14.

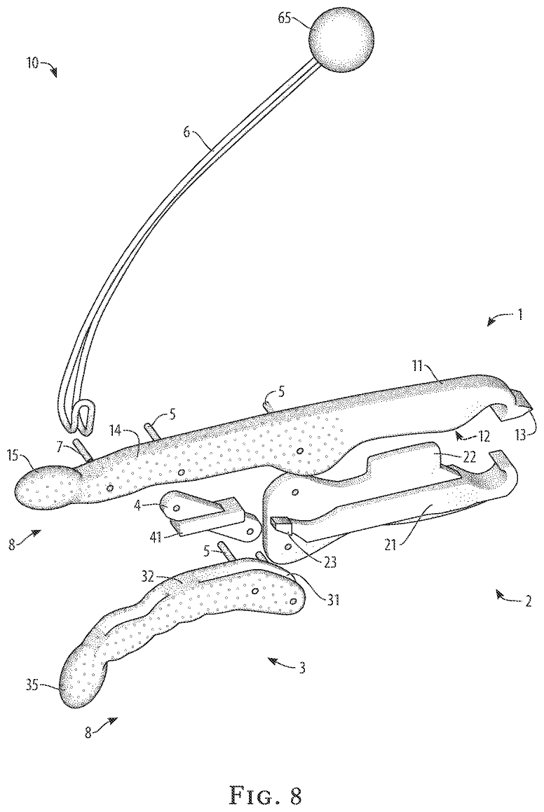

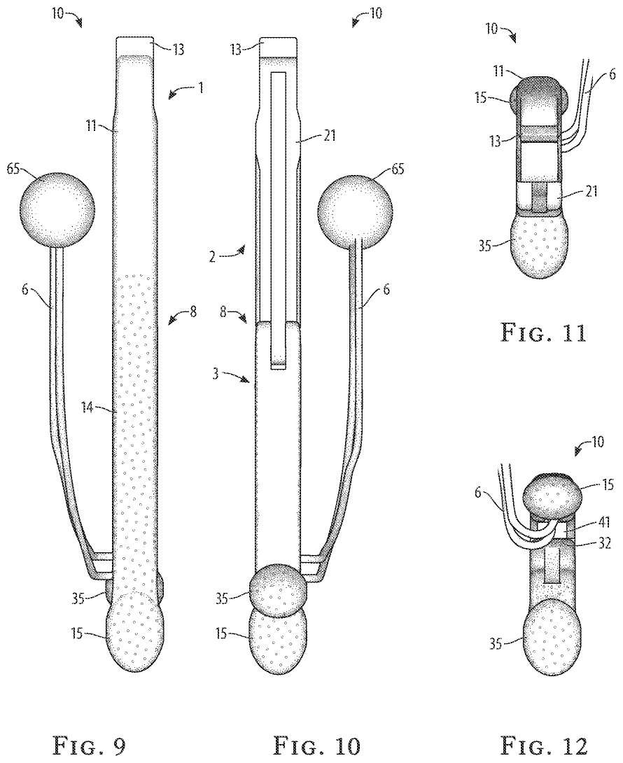

Referring to FIG. 9, FIG. 10, FIG. 11, and FIG. 12, the fish holding tool 10 is designed to be both safe and easy to take in hand and to use on a struggling caught fish, with molded grip texture 8 on the surfaces to be held in the hand of the user, and smooth surfaces on the jaws which are inserted into the mouth of the fish, which action is facilitated by the tapered extending tip 13. The upper-handle bulbous end 15 and the lower-handle bulbous end 35 provide for a sure grip and eliminate any dangerous or uncomfortable sharpness at the ends of the handles, and can be made hollow or otherwise extra buoyant, such as with a closed-cell foam insert, to increase the buoyancy of the entire fish holding tool 10. The lanyard 6 provides for a secure hold on the fish holding tool 10, and the buoyant lanyard-end terminator 65, which can also be made hollow or otherwise extra buoyant, increases the overall buoyancy and provides a way to retrieve the fish holding tool 10 from the bottom of a boat or from the water.

Many other changes and modifications can be made in the apparatus of the present invention without departing from the spirit thereof. We therefore pray that our rights to the present invention be limited only by the scope of the appended claims.

We claim:

1. A fish holding tool for safe and secure holding of a caught fish, having, in use, open and closed positions and a nominal orientation of front, back, top, bottom, left and right sides, and a width between the sides, the fish holding tool comprising:
(i) an upper member comprising:
(a) at the front an upper jaw adapted to grip the inside of the mouth of the fish, having a tapered extending tip adapted to facilitate opening the mouth of the fish;
(b) at the back an upper handle having an upper-handle bulbous end adapted to facilitate secure gripping; and
(c) along the bottom an upper-member slot having a width;
(ii) a lower jaw adapted to grip the outside of the mouth of the fish comprising:
(a) along the sides a lower-jaw strut adapted to resist deformation;
(b) at the back of said lower-jaw strut a lower-jaw double stop adapted to limit the angle of opening and resist over-closing of said lower jaw; and
(c) at the top a lower-jaw tab having a width corresponding to the width of said upper-member slot, adapted fit into said upper-member slot in a closed position to resist deformation of said lower jaw;
said lower jaw joined to said upper jaw with a first non-corroding pivot pin forming a pivot joint having one degree of freedom;
(iii) a lower handle adapted to control opening and closing of said fish holding tool comprising:
(a) at the back a lower-handle bulbous end adapted to facilitate secure gripping;
(b) at the top a lower-handle brace providing an un-slotted area; and
(c) at the front a lower-handle slot having a width;
said lower handle joined to said upper handle with a second non-corroding pivot pin forming a pivot joint having one degree of freedom;
(iv) a toggle linkage adapted to facilitate a toggled opening and closing of said fish holding tool, having at one end a width corresponding to the width of said upper-member slot and at the other end a width corresponding to the width of said lower-handle slot, having a toggle-linkage bumper adapted to, when closed, in use, stop against said upper member above and against said lower-handle brace below, preventing further closing of said fish holding tool;
said toggle linkage joined to said lower jaw with a third non-corroding pivot pin forming a pivot joint having one degree of freedom;
said toggle linkage further joined to said upper handle with a fourth non-corroding pivot pin forming a pivot joint having one degree of freedom;
(v) a lanyard adapted to provide a secure grip on said fish holding tool in use, having a buoyant lanyard-end terminator adapted to provide increased buoyancy mounted upon said upper handle with a non-corroding lanyard pin; and
(vi) a molded grip texture upon said upper handle and said lower handle adapted to provide a secure grip on said fish holding tool in use;
where said fish holding tool functions as a planar four-bar toggle linkage.

2. The fish holding tool of claim 1, where said toggle-linkage bumper is further adapted to strengthen said toggle linkage.

3. The fish holding tool of claim 1, where the width of said upper-member slot and said lower-handle slot are the same width.

4. The fish holding tool of claim 1, where said upper-handle bulbous end is further adapted to provide increased buoyancy.

5. The fish holding tool of claim 1, where said lower-handle bulbous end is further adapted to provide increased buoyancy.

6. The fish holding tool of claim 1, where said buoyant lanyard-end terminator is further adapted for taking up and retrieving said fish holding tool.

7. The fish holding tool of claim 1, where said molded grip texture further comprises raised dots.

8. The fish holding tool of claim 1, where said molded grip texture further comprises ridges.

9. The fish holding tool of claim 1, where said fish holding tool is made of a plastic material.

10. The fish holding tool of claim 1, where said fish holding tool is made of a resin material.

11. The fish holding tool of claim 1, where said fish holding tool is made of a composite material.

12. The fish holding tool of claim 1, where said fish holding tool is made of a silicone material.

13. The fish holding tool of claim 1, where said fish holding tool is made of a foam material.

14. The fish holding tool of claim 1, where said fish holding tool is made of a closed-cell foam material.

15. The fish holding tool of claim 1, further comprising manufacture with sealed hollow chambers for increased buoyancy.

16. The fish holding tool of claim 1, further comprising manufacture with a foaming process to form air bubbles for increased buoyancy.

17. The fish holding tool of claim 1, further comprising manufacture with inclusion of cellulosic material for increased buoyancy.

18. The fish holding tool of claim 1, further comprising manufacture with inclusion of sawdust for increased buoyancy.

19. The fish holding tool of claim 1, where said upper member has an average width of between 0.7″ to 0.8″, inclusive.

20. The fish holding tool of claim 1, where said upper member has an overall length of between 10″ to 11″, inclusive.
